(19) United States
(12) Patent Application Publication
(10) Pub. No.: US 2008/0104044 A1
(43) Pub. Date: May 1, 2008

(54) System and method for the remote operation and management of networked multi-function peripheral (MFP) devices via web feeds

(76) Inventors: Constantinos Kardamilas, Irvine, CA (US); Mark Gaines, Hawthorne, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/589,583

(22) Filed: Oct. 30, 2006

(51) Int. Cl. G06F 17/30

(52) U.S. Cl. 707/4

(57) ABSTRACT

A web feed notification system and method for multi-function peripheral devices (MFPS) is disclosed. A notification condition is detected in a multi-function peripheral having a communications interface. A notification web feed indicative of the notification condition is assembled. Subscribed client devices detect the updated web feed and download the web feed accordingly. In certain embodiments, web feed subscriptions may be restricted to certain types of clients based on their permission roles.

### BACKGROUND

1. Field of the Invention

The invention relates to multi-function peripheral devices. More particularly, the invention relates to operating and managing multi-function peripheral devices via web feeds.

2. Description of the Related Art

A multi-function peripheral (MFP) device is an office or home machine that typically includes a printer, scanner, copier and facsimile (fax) capability. The MFP is also known as a multi-function printer or product, a multi-functional, an all-in-one (AiO), a copier or a multi-function device (MFD). Some MFP devices do not include the fax capability, while in other MFP devices, the fax capability is optional. Some MFP devices can include a media card reader capability and/or one or more hard disks. Existing MFP devices have limited notification abilities. Typically, notification is only available by manually accessing the MFP via a computer network. The notification is typically provided through a print driver of the MFP, remote user interface (UI) client software, or via a web browser client. A user of the MFP must have a computer on the network and may need to have special printer-specific software installed to remotely or locally access notifications for the printer. A MFP user using this prior technique is required to constantly access the printer manually to receive prompt notification.

### SUMMARY OF CERTAIN INVENTIVE ASPECTS

Thus, it would be advantageous to develop a method and system for enhancing notification for a user of a MFP.

The systems and methods disclosed herein provide for enhanced notification for a user of a MFP by automatically updating a web feed that is subscribed to by the user with events such as an error or status condition from the MFP. A MFP may provide different web feeds for different events, and may further provide subscription options for each type of web feed so that a user may subscribe to feeds of his or her choosing. Furthermore, certain web feed subscriptions may be restricted to certain types of users.

One embodiment includes a method of managing web feeds from a multi-function peripheral. The method comprises configuring an MFP to issue at least one web feed, and providing the subscription options for the at least one web feed.

In certain embodiments, the method may further comprise configuring the MFP remotely via a web browser. In certain embodiments, the method may further comprise configuring the MFP locally using a device interface. In certain embodiments, the at least one web feed may be subscribed to by a plurality of users. In certain embodiments, the MFP transmits a plurality of web feeds. In certain embodiments, the plurality of web feeds includes an error feed, a warning feed, a status feed, and a data feed, such as a Podcast. In certain embodiments, the subscription options include permission roles allowed to subscribe to the feed. In certain embodiments, the at least one web feed is issued to a subscribed user based on the permission role of the subscribed user. In certain embodiments, the permission roles include a user role, an administrator role, and a guest role. In certain embodiments, only a subscribed user with an administrator role is permitted to configure the MFP. In certain embodiments, the web feed is a Really Simple Syndication (RSS) format feed.

Another embodiment includes a system for managing web feeds from a multi-function peripheral. The system comprises a feed generator module configured to instruct an MFP to issue at least one web feed, a subscription module configured to provide subscription options for the at least one web feed, and a communications module configured to transmit the at least one web feed to a subscribed user of the feed.

In certain embodiments, the subscription module includes remote access via a web browser. In certain embodiments, the subscription module includes local access using a device interface. In certain embodiments, the at least one web feed may be subscribed to by a plurality of users. In certain embodiments, the communications module is configured to transmit a plurality of web feeds. In certain embodiments, the plurality of web feeds includes an error feed, a warning feed, a status feed, and a data feed, such as a Podcast. In certain embodiments, the subscription module is configured to provide permission roles to allow users to subscribe to the feed. In certain embodiments, the at least one web feed is issued to a subscribed user based on the permission role of the subscribed user. In certain embodiments, the permission roles include a user role, an administrator role, and a guest role. In certain embodiments, only a subscribed user with an administrator role is permitted to configure the feed generator module. In certain embodiments, the web feed is a Really Simple Syndication (RSS) format feed.

A further embodiment includes a computer-readable medium storing instructions. The instructions, when executed, perform a method comprising configuring an MFP to issue at least one web feed, and providing the subscription options for the at least one web feed.

Yet another embodiment includes a system for managing web feeds from a multi-function peripheral. The system comprises means for configuring an MFP to issue at least one web feed, and means for providing the subscription options for the at least one web feed.

Neither this summary nor the following detailed description purports to define the invention. The invention is defined by the claims. For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

These and other features will now be described with reference to the drawings summarized below. These drawings and the associated description are provided to illustrate a preferred embodiment of the invention, and not to limit the scope of the invention.

FIG. 1 schematically illustrates a network environment in which embodiments of the invention can be implemented.

FIG. 2 is a diagram of certain components of the MFP shown in FIG. 1.

FIG. 3 is a flowchart of an exemplary web feed configuration process such as used in the system shown in FIG. 1.

FIG. 4 is a screen display of an exemplary notification permissions menu or dialog box used in the system shown in FIG. 1.

FIG. 5 is a screen display of an exemplary notification subscriptions menu or dialog box used in the system shown in FIG. 1.

FIG. 6 is a flowchart of an exemplary web feed notification process such as used in the system shown in FIG. 1.

### DETAILED DESCRIPTION OF CERTAIN INVENTIVE EMBODIMENTS

The following detailed description presents various descriptions of specific embodiments of the invention. However, the invention can be embodied in a multitude of different ways as defined and covered by the claims. In this description, reference is made to the drawings wherein like parts are designated with like numerals throughout.

The system modules, tools, and applications described herein may be written in any programming language such as, for example, C, C++, BASIC, Visual Basic, Pascal, Ada, Java, HTML, XML, or FORTRAN, and executed on an operating system, such as variants of Windows, Macintosh, UNIX, Linux, VxWorks, or other operating system. C, C++, BASIC, Visual Basic, Pascal, Ada, Java, HTML, XML and FORTRAN are industry standard programming languages for which many commercial compilers can be used to create executable code.

### System Configuration

Various embodiments may be practiced in networked environment. As used herein, a network may refer to a network or combination of networks spanning any geographical area, such as a local area network, wide area network, regional network, national network, and/or global network. The Internet is an example of a current global computer network. Those terms may refer to hardwire networks, wireless networks, or a combination of hardwire and wireless networks. Hardwire networks may include, for example, fiber optic lines, cable lines, ISDN lines, copper lines, etc. Wireless networks may include, for example, cellular systems, personal communications service (PCS) systems, satellite communication systems, packet radio systems, and mobile broadband systems. A cellular system may use, for example, code division multiple access (CDMA), time division multiple access (TDMA), personal digital phone (PDC), Global System Mobile (GSM), General Packet Radio Service (GPRS), frequency division multiple access (FDMA), or third generation or newer mobile communication systems, such as Universal Mobile Telecommunications System (UMTS) or CDMA2000 based on the International Mobile Telecommunications-2000 (IMT-2000) standard, among others.

The systems and methods embodying the present invention may be used to enhance existing methods of system status or event notification by utilizing networking technology such as web feeds to make available notifications from the MFP to the user. The ability for a MFP user to be automatically notified from the MFP via their networked device, such as a desktop or handheld computing device with communications capability, allows the user greater convenience and time efficiency.

Using existing methods, a MFP user is required to actively access an MFP to receive a notification. The MFP user may not, however, have the time to manually access the MFP in order to determine if any relevant notifications have issued. Using the system and method described herein, the MFP user is informed of relevant MFP notifications via a subscription to a web feed that promptly notifies the user via his computing device, such as by using commonly available tools to display web feeds from the MFP in a timely and prioritized way.

Furthermore, the MFP user has local access to information for a remote MFP device due to the web feed subscription. A MFP user may also consolidate the MFP web feed with web feeds from other sources. As discussed herein, in one embodiment a web feed is a document which contains a sequence of content.

The system and method enhances notification by taking advantage of network software that is typically available for a computing device. The MFP may be configured to provide updated web feeds that any number of MFP users may receive. Typical notifications sent would be error conditions such as “out of paper” or “paper jam” that need prompt attention, warning conditions such as “low on toner” or “low on paper” that need later attention, and status conditions such as “fax received” or “document printed” that may need no attention. However, notification web feeds do not need to be limited to these conditions. The MFP could also be used for other web feeds.

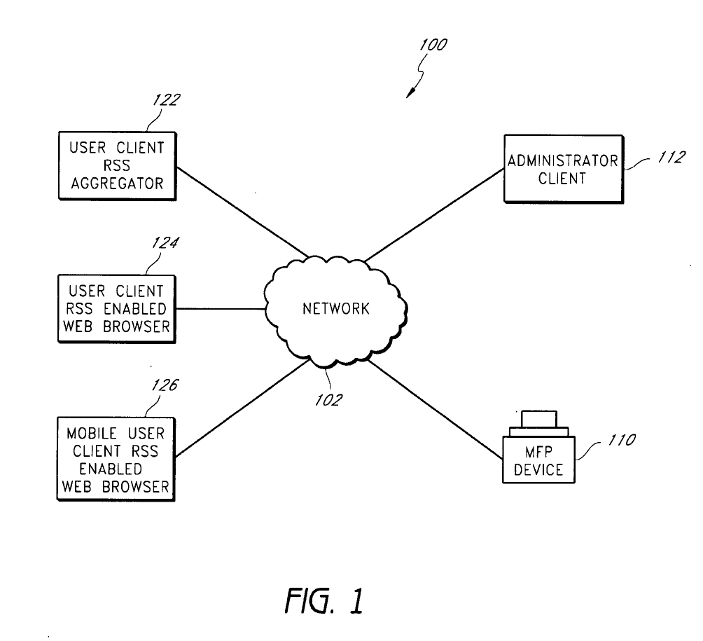

FIG. 1 illustrates one embodiment of a web feed notification system 100 comprising a MFP 110 connected to a data communications network 102, such as the Internet. In other embodiments, a MFP 110 may be connected to any electronic communications network, such as a local area network. In certain embodiments, a plurality of MFPs may be connected to a network. The connections may be wired or wireless. In certain embodiments, the system 100 may further comprise an administrator client 112 from which an administrator of the MFP 110 may configure its web feed functionality. In other embodiments, the administrator may configure the MFP's 110 web feed functionality without the use of an administrator client 112 by directly using a front panel on the MFP's 110 interface.

Multiple users 122, 124 and 126 may subscribe to web feeds over the network 102. The embodiment shown in FIG. 1 uses a RSS web feed format, although in other embodiments other web feed formats may be used, such as Atom. Various applications may be used to receive publications of the RSS web feed to which the user is subscribed, including a conventional RSS enabled web browser 124 and 126 and a conventional RSS aggregator 122.

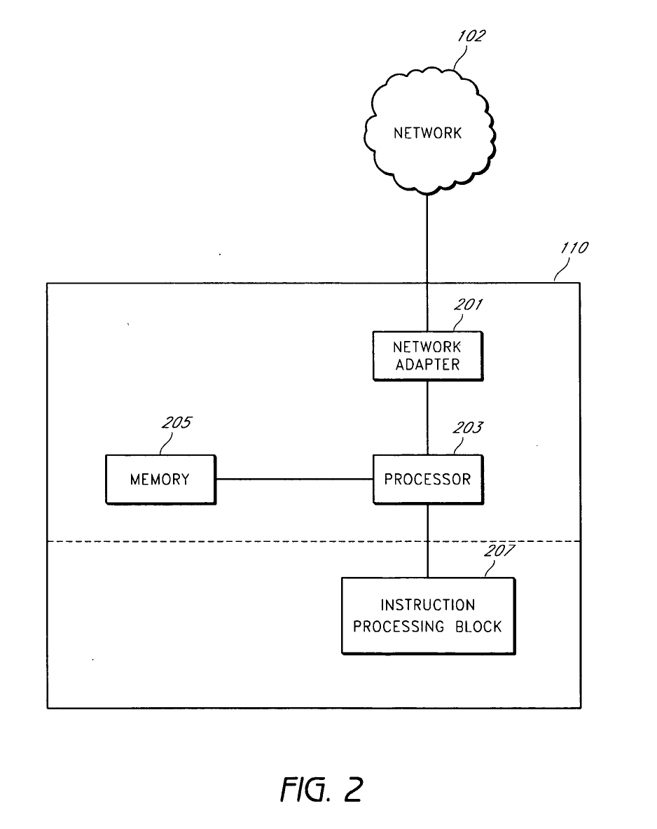

FIG. 2 illustrates a schematic block diagram of a web feed capable MFP according to one embodiment of the invention. The device 110 has a network adaptor 201 for providing an interface between the remaining components of the device 110 and the network 102 to which the device 110 is connected. The network adaptor 201 may have a wired or wireless connection to the network 102. Web feeds may be sent through the network adaptor 201 to the network 102 where they may later be delivered to the appropriate client system for a user subscribed to the web feed (hereinafter, “client” or “subscribed user” or “subscriber”). In the illustrated embodiment, the device 110 includes a processor 203, a memory 205, and an instruction processing block 207.

In the illustrated embodiment, the memory 205 stores identification information of users who are authorized to access and use the device 110, as well as subscribed users and their subscription options. In some embodiments, the memory 205 is a rewritable memory or a read-only memory having pre-stored data and optionally programs, such as a program capable of creating and sending web feeds. In one embodiment, the memory 205 is a non-volatile memory, such as a hard disk drive, a non-volatile random access memory (RAM), or a flash memory, for example. In other embodiments, the memory 205 may be a volatile memory, in which each user's authorized identification information is stored at least while the device 110 is operating. In one embodiment of the volatile memory, the authorized identification information is copied to the memory 205 from another source when or soon after the device 110 is powered up. In certain embodiments, the authorized identification information is received from the network 102.

The instruction processing block 207 is designed to process task instructions that are received from the network 102. The block 207 is also designed to process task instructions such as configuring and issuing web feeds. Although not illustrated in detail, the instruction processing block 207 may include its own processor, memory, and other components. In some embodiments, the processor 203 and the processor of the block 207 may be implemented in a single chip or in separate chips. Also, the memory 205 and the memory of the block 207 may be implemented in a single memory device or as separate memory devices.

### Configuration Process

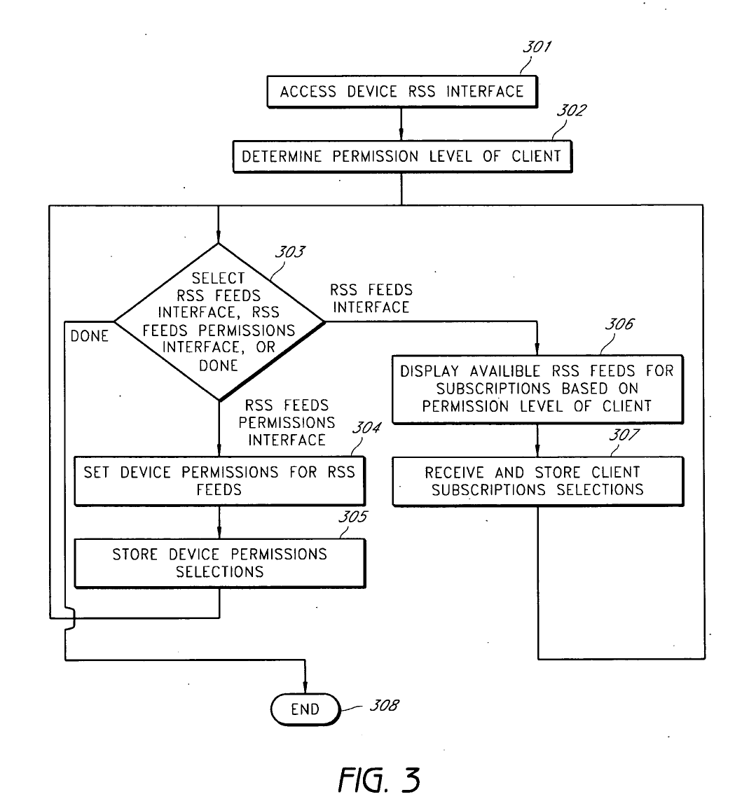

FIG. 3 illustrates a sample configuration process for the MFP 110 according to one embodiment of the invention. Beginning at state 301, a user accesses the interface for the MFP 110 via a client system 124. In response, the process proceeds to state 302 where the MFP 110 determines the permission role of the client 124. Moving to a decision state 303, the client system is presented with three options: accessing the RSS feeds interface, accessing the RSS feeds permissions interface, or to exit.

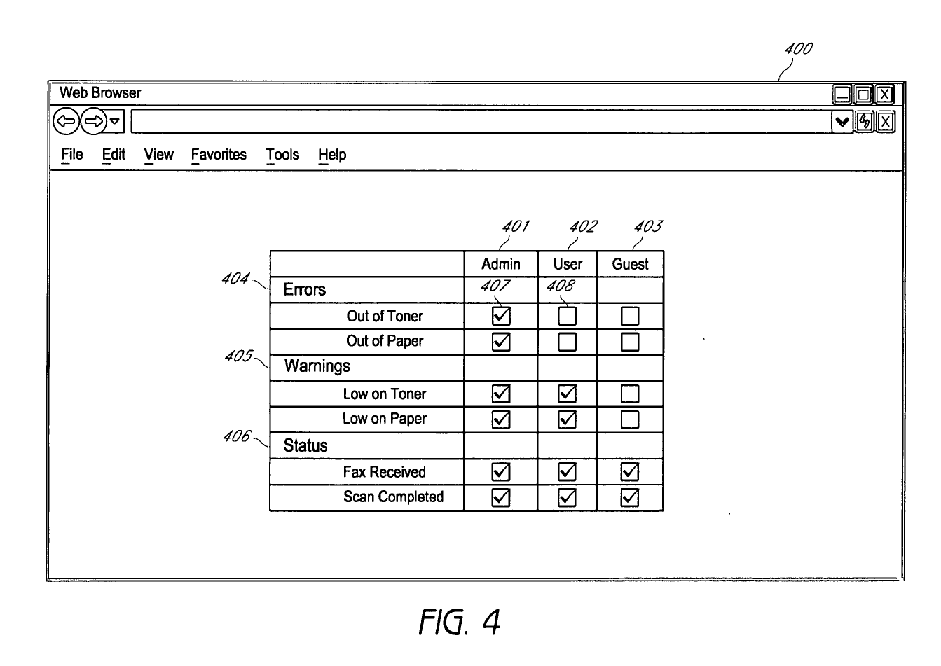

If the user of the client system selects the RSS feeds permissions interface, the process moves to state 304 where the user may configure the level of permission required to subscribe to an RSS feed using a permissions menu displayed by the MFP 110. FIG. 4 is a screen display of an exemplary notification permissions menu or dialog box 400 used in the system shown in FIG. 1. In the embodiment shown, there are three permission roles or categorizations for a user: administrator 401, user 402, and guest 403. In other embodiments, their may be different names for the permission roles or a different number of permission roles altogether. In certain embodiments, only a user of a client system with an “administrator” permission role 401 may be allowed to access and configure the RSS feeds permissions interface 400. In other embodiments, other permission roles may be granted access to configure the permissions interface 400. In certain embodiments, RSS feeds with a “guest” permission role 403 may be available to all users, while feeds with “administrator” 401 or “user” 402 permission roles will only be available to users that have completed authorization to gain the respective permission roles using existing device procedures.

Categories may also be assigned to the types of RSS feeds that are available. In the sample screen display 400 shown, three categories of RSS feeds are displayed: errors 404, warnings 405, and status 406. In other embodiments, other category names may be used, and a different number of categories may be available.

The permissions interface 400 can be used to configure different subscription options for users based on their permission role, such as which types of notification web feeds within a category are available for subscription. For example, as demonstrated by the checked and unchecked boxes in the screen display 400, a user of a client system with an “administrator” permission role 401 may subscribe to the error notification RSS feed for being out of toner 407, while a client system with a “user” permission role 402 does not have the option to subscribe to the error notification RSS feed for being out of toner 408. The MFP 110 receives and stores the permissions selections in the following state, state 305, and the process moves back to decision state 303.

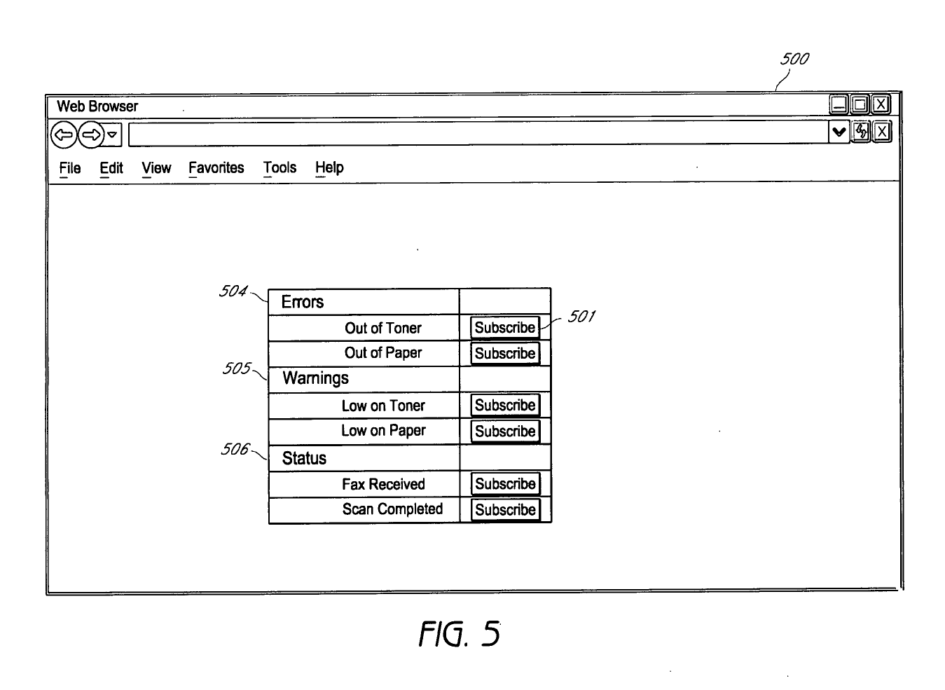

If at decision state 303 the user of the client system selects to access the RSS feeds interface, the process moves to state 306, where RSS feeds available to the user for subscription based on the user's permission role are displayed. In certain embodiments, the subscription menu only displays categories available for subscription to a user based on the user's permissions level. In other embodiments, all categories may be displayed, but a user may only be able to subscribe to RSS feeds available to the user's permissions level. FIG. 5 is a screen display of an exemplary notification subscriptions menu or dialog box 500 used in the system shown in FIG. 1. The illustrated subscription menu 500 provides available subscription options for a user of a client system with a priority level of administrator, since the user has the option to subscribe to all available feeds. The RSS notification feeds are organized into the same categories of the permissions interface 400: errors 504, warnings 505 and status 506. A user may thus use the subscriptions menu 500 to subscribe to available notification RSS feeds by selecting the available subscription buttons 501 for each feed. The MFP 110 then receives and stores the client system's subscription selections in the following state, state 307, and then the process moves back to decision state 303. A user may unsubscribe from a feed using a RSS aggregation tool or a RSS-enabled browser, as discussed earlier.

If at decision state 303 the user of the client system selects to exit, the process completes at an end state 308.

### Notification Process

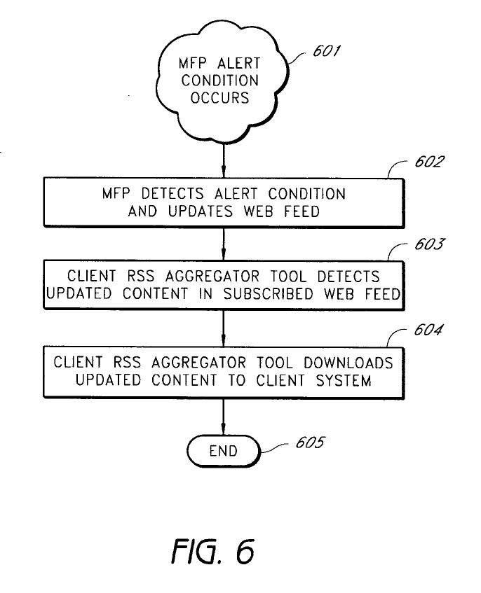

FIG. 6 illustrates a sample notification process for the MFP 110 according to one embodiment of the invention. In certain embodiments, the notification process is a software program executed by the MFP 110. When a condition of interest arises in the MFP 110, web feed notification is performed. The MFP 110 updates its web feed content with information on the condition of interest. The client system, such as devices 122, 124 and 126, monitoring the subscribed web feed then downloads or otherwise receives the updated web feed content from the MFP 110.

Beginning at a state 601, a MFP notification condition occurs in the MFP 110. Advancing to state 602, the MFP 110 detects the notification condition and updates the relevant web feed. Proceeding to state 603, a client device 122 which is currently subscribed to the web feed detects the updated content in the web feed. Detection may occur using a RSS aggregator, as illustrated, or using a RSS enabled browser, as discussed above. The RSS aggregator on the client device 122 then proceeds to download the updated web feed. The process completes at an end state 606.

### Alternative Embodiments

The system and method include embodiments where the web feed may be used for a variety of notification types. In certain embodiments, the web feed may be used to notify subscribed users of the current state of a task submitted to the MFP 110, such as a print job. For example, the web feed may notify subscribed users when a print job is submitted, its percentage of completion, and when the print job is completed. In certain embodiments, the web feed may be used to notify subscribed users when data, such as a fax received from an external source, becomes available and to provide the data in the appropriate format. For example, the web feed may notify subscribed users when a fax is received, and send the fax to a subscribed user via the web feed using an appropriate format. In certain embodiments, the web feed may be used to notify subscribed users when the configuration of the MFP 110 changes, such as if the MFP 110 receives a software or hardware upgrade, or if relevant documentation or software for the MFP 110 is released.

The system and method include an embodiment where the source of the notification may be a client connected to the MFP 110. The MFP 110 may receive the client notification, process it and then send a notification to the appropriate subscriber.

### CONCLUSION

Using the systems and methods disclosed herein, an MFP user will be informed of relevant MFP notifications via a subscription to a web feed that promptly notifies the user via his computing device of events associated with the MFP. Commonly available tools may display the MFP web feeds for the user in a timely and prioritized way. Furthermore, the MFP user has local access to information for a remote MFP device due to the web feed subscription. A MFP user may also consolidate the MFP web feed with web feeds from other sources.

While specific blocks, sections, devices, functions and modules may have been set forth above, a skilled technologist will realize that there are many ways to partition the system, and that there are many parts, components, modules or functions that may be substituted for those listed above.

Moreover, the terminology used in the description presented herein is not intended to be interpreted in any limited or restrictive manner, simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described. As can be appreciated by one of ordinary skill in the art, each of the modules described herein may comprise various sub-routines, procedures, definitional statements and macros. The various modules may be separately compiled and linked into a single executable program. Thus, the foregoing description of each of the modules is used for convenience to describe the functionality of the preferred system and not intended to require a specific modular structure. In fact, the processes that are performed and undergone by each of the modules may be redistributed to one of the other modules, combined together in a single module, or made available in, for example, a shareable dynamic link library.

While the above detailed description has shown, described, and pointed out the fundamental novel features of the invention as applied to various embodiments, it will be understood that various omissions and substitutions and changes in the form and details of the system illustrated may be made by those skilled in the art, without departing from the intent of the invention.

What is claimed is:

1. A method of managing web feeds from a multi-function peripheral (MFP), the method comprising:
receiving an instruction to publish at least one web feed;
publishing the at least one web feed in response to the instruction;
receiving a subscription request for the at least one web feed; and
providing subscription options for the at least one web feed in response to the subscription request.

2. The method of claim 1, wherein the instruction is received from a remote computing device via a web browser.

3. The method of claim 1, wherein the instruction is received from input into a device interface of the MFP.

4. The method of claim 1, wherein the at least one web feed may be subscribed to by a plurality of users.

5. The method of claim 1, wherein the MFP publishes a plurality of web feeds.

6. The method of claim 5, wherein the plurality of web feeds includes an error feed, a warning feed, a status feed, and a data feed.

7. The method of claim 1, wherein the subscription options include permission roles allowed to subscribe to the feed.

8. The method of claim 6, wherein the at least one web feed is accessible to a subscribed user based on the permission role of the subscribed user.

9. The method of claim 6, wherein the permission roles include a user role, an administrator role, and a guest role.

10. The method of claim 8, wherein only a user with an administrator role is permitted to configure the MFP.

11. The method of claim 1, wherein the web feed is a Really Simple Syndication (RSS) format feed.

12. A system for managing web feeds from a multi-function peripheral (MFP), the system comprising:
a feed generator module configured to instruct an MFP to issue at least one web feed;
a subscription module configured to provide subscription options for the at least one web feed; and
a communications module configured to publish the at least one web feed for a subscribed user of the feed.

13. The system of claim 12, wherein the subscription module includes remote access via a web browser.

14. The system of claim 12, wherein the subscription module includes local access using a device interface.

15. The system of claim 12, wherein the at least one web feed may be subscribed to by a plurality of users.

16. The system of claim 12, wherein the communications module is configured to publish a plurality of web feeds.

17. The system of claim 16, wherein the plurality of web feeds includes an error feed, a warning feed, a status feed, and a data feed.

18. The system of claim 12, wherein the subscription module is configured to provide permission roles to allow users to subscribe to the feed.

19. The system of claim 18, wherein the at least one web feed is accessible to a subscribed user based on the permission role of the subscribed user.

20. The system of claim 18, wherein the permission roles include a user role, an administrator role, and a guest role.

21. The system of claim 20, wherein only a user with an administrator role is permitted to configure the feed generator module.

22. The system of claim 12, wherein the web feed is a Really Simple Syndication (RSS) format feed.

23. The system of claim 12, wherein the system comprises an MFP.

24. A computer-readable medium storing instructions that when executed perform a method comprising:
receiving an instruction to publish at least one web feed;
publishing the at least one web feed in response to the instruction;
receiving a subscription request for the at least one web feed; and
providing subscription options for the at least one web feed in response to the subscription request.

25. A system for managing web feeds from a multi-function peripheral (MFP), the system comprising:
means for receiving an instruction to publish at least one web feed;
means for publishing the at least one web feed in response to the instruction;
means for receiving a subscription request for the at least one web feed; and
means for providing subscription options for the at least one web feed in response to the subscription request.
